(19) United States
(12) Patent Application Publication
(10) Pub. No.: US 2024/0373539 A1
(43) Pub. Date: Nov. 7, 2024

(54) ARC-EROSION RESISTANT NOZZLES FOR PLASMA ARC MATERIAL PROCESSING SYSTEMS

(71) Applicant: Hypertherm, Inc., Hanover, NH (US)

(72) Inventors: Yu Zhang, Hanover, NH (US); Markus Wittman, Hanover, NH (US); Steven Moody, Charlestown, NH (US); Dennis Kulakowski, Corinth, VT (US); Soumya Mitra, Lebanon, NH (US)

(21) Appl. No.: 18/654,787

(22) Filed: May 3, 2024

Related U.S. Application Data
(60) Provisional application No. 63/464,028, filed on May 4, 2023.

(51) Int. Cl. H05H 1/34; H05H 1/28

(52) U.S. Cl. CPC H05H 1/3457; H05H 1/28

(57) ABSTRACT

A nozzle for a gas-cooled plasma arc torch is provided. The nozzle includes a nozzle body formed from a first metal. The nozzle body comprises a proximal portion and a distal portion extending along a longitudinal axis. The distal portion of the nozzle body comprises a first bore. The nozzle also includes an arc transition component formed from a second metal. The arc transition component is coupled to the distal portion of the nozzle body and comprises a second bore configured to substantially align with the first bore when the arc transition component is coupled to the nozzle body. The second metal of the arc transition component comprises a noble metal and the second metal is different from the first metal.

### CROSS REFERENCE TO RELATED APPLICATION

This application claims benefit of and priority to U.S. Provisional Patent Application No. 63/464,028, filed on May 4, 2023, the entire content of which is owned by the assignee of the instant application and incorporated herein by reference in its entirety.

### TECHNICAL FIELD

The present invention generally relates to nozzles for gas-cooled plasma arc processing systems, where the nozzles are configured to resist arc erosion.

### BACKGROUND

Material processing apparatus, such as plasma arc torches and lasers, are widely used in the heating, cutting, gouging and marking of metallic materials known as workpieces. For example, a plasma are torch generally includes a torch body, consumables, such as an electrode and a nozzle having a central exit orifice mounted within the torch body, electrical connections, and passages for cooling and arc control fluids (e.g., plasma gas). Optionally, a swirl ring is employed to control fluid flow patterns in the plasma chamber formed between the electrode and the nozzle. In some plasma arc torches, a retaining cap can be used to maintain the nozzle and/or the swirl ring in the torch body. Gases used in the torch can be non-oxidizing (e.g., argon or nitrogen), or oxidizing (e.g., oxygen or air). A plasma are torch is configured to produce a plasma arc, which is a constricted ionized jet of a plasma gas with high temperature and high momentum.

One method for producing a plasma arc in a plasma arc torch is the contact start method. The contact start method involves establishing physical contact and electrical communication between the electrode and the nozzle to create a current path between them. The electrode, swirl ring, and the nozzle can cooperate to create a plasma chamber within the torch body. An electrical current is provided to the electrode and the nozzle, and a process gas is introduced to the plasma chamber. Pressure of the process gas builds up until the pressure is sufficient to separate the electrode and the nozzle. The separation causes an are to be formed between the electrode and the nozzle in the plasma chamber. Hereinafter, this plasma arc is referred to as a pilot arc and the torch operation with the are attached to the nozzle is referred to as a pilot arc mode. The pilot arc ionizes the introduced process gas to produce a plasma jet that can be transferred to the workpiece for material processing. Hereinafter, this plasma arc is referred to as a transferred arc and the torch operation with the plasma are transferred is referred to as a transferred arc mode. In some applications, a power supply connected to the plasma arc torch is adapted to provide a first electrical current known as a pilot current during generation of the arc in the pilot are mode and a second current known as a transferred are current when the plasma jet has been transferred to the workpiece in the transferred are mode.

A traditional plasma arc torch can deteriorate quickly if the torch is used in pilot arc mode (e.g., where the pilot arc extends from the electrode to the nozzle rather than to the workpiece) for an extended period of time. The pilot arc mode is used in a variety of situations, including at the start of a plasma processing operation, to provide light in dark spaces, interrupted cutting operations, cutting uneven surfaces, etc. Pilot arcing can significantly decrease the useful life of the nozzle in the plasma arc torch. More specifically, during the pilot arc mode for operating a plasma arc torch (e.g., every time the torch is fired), a pilot arc is formed between the electrode and the inner face of the nozzle surrounding the nozzle exit orifice. Then the pilot arc quickly proceeds through the nozzle exit orifice and remains attached to the outer nozzle face surrounding the nozzle exit orifice. During this period and before arc transfers to the workpiece, the pilot arc current and oxygen in the process gas can produce rapid wear to the nozzle around the outlet of the nozzle exit orifice. Such nozzle wear degrades the torch's cutting capability and severely limits consumable life.

In some cases, a nozzle is packaged together with one or more other torch consumable components, including an electrode, swirl ring and/or shield, to form a cartridge. The set of consumable components in the cartridge may not be individually disposable or serviceable. While the introduction and adoption of cartridges in plasma arc torches has driven a wave of innovation in the plasma arc cutting field and created a more robust solution and product for the end user, one downside is that the use of a cartridge that incorporates a standard nozzle (e.g., an all-copper nozzle) in high pilot arc applications can result in high consumable cost as an operator cannot selectively replace only the part that is approaching the end of life/has failed, but must replace the entire cartridge. That is, failure of one component in a cartridge, such as the nozzle, means that the entire cartridge becomes unusable. Therefore, in practice, for applications with significant pilot arc time, the nozzle and/or the entire consumable cartridge needs to be changed long before other consumables (e.g., the electrode) have reached the end of its life.

Recently, plasma arc processing systems have been integrated into robotic manufacturing cells to perform various operations, such as trimming flash from aluminum castings. The variability in flash locations and flash continuity requires the plasma arc torch in a robotic manufacturing system to maintain a continuous pilot arc over workpiece contours where flash may occur, regardless of presence. When the torch passes near flash, the plasma arc is adapted to transfer to the workpiece to commence cutting and removal of the flash from the casting. This operation is efficient in trimming the flash, but results in significant pilot arc (i.e., non-transferred arc) operation time of the plasma consumables, which significantly reduces consumable life because the arc termination (anode) continuously transitions between the nozzle (in pilot arc mode) when flash is absent and the workpiece (transferred arc) when flash is present. In addition, due to part variation and limitations in robotic motion control, these applications benefit from an elevated torch standoff (i.e., elevated torch-to-workpiece distance) to avoid torch collisions. However, such preference exasperates nozzle wear and further degrades the usable life of nozzles, other torch consumables and/or cartridges. In addition, consumables (e.g., nozzles) used in robotic manufacturing applications are particularly sensitive to cut life as replacement of old consumables for new ones require shutdown of one or more robotic cells, thus resulting in production losses.

In general, long pilot arc time can result in premature nozzle wear and low overall consumable cartridge life, thereby increasing consumable cost. As described above, examples of applications that require significant pilot arc time include, but are not limited to, an operator using the torch as a light source, robotic applications with imprecise and/or unpredictable workpiece edge locations, grate cutting, robotic aluminum cast cutting, and trimming operations where average pilot arc time per start can be 5 to 10 times that of a traditional cut table application. For instance, in robotic applications where cartridges are installed inside of plasma arc torches, less than 1% of the cartridges are used up due to electrode blow out. Instead in many cases, an overwhelming majority of cartridges are replaced due to premature nozzle wear. Such premature needs for cartridge replacement limit the advantages of cartridge usage. In applications where consumables are individually replaceable (i.e., not a part of a cartridge), customers can use up to 2 nozzles per electrode.

Therefore, systems and methods are needed to reduce nozzle wear in a plasma arc processing system due to pilot arcing without compromising processing performance.

### SUMMARY

The present invention features multi-material composite nozzles configured to reduce pilot arc erosion. In one aspect, a nozzle for a gas-cooled plasma arc torch is provided. The nozzle includes a nozzle body formed from a first metal. The nozzle body comprises a proximal portion and a distal portion extending along a longitudinal axis. The distal portion of the nozzle body comprises a first bore. The nozzle also includes an arc transition component formed from a second metal. The arc transition component is coupled to the distal portion of the nozzle body and comprises a second bore configured to substantially align with the first bore when the arc transition component is coupled to the nozzle body. The second metal of the arc transition component comprises a noble metal and the second metal is different from the first metal.

In another aspect, a consumable cartridge for a gas-cooled plasma arc torch is provided. The consumable cartridge comprises a composite nozzle including a nozzle body formed from a first metal and an arc transition component formed from a second metal different from the first metal. The arc transition component is coupled to a distal end of the nozzle body along a longitudinal axis of the nozzle. The consumable cartridge also includes an electrode disposed within a portion of the nozzle, a swirl ring disposed about the electrode and fixedly connected to the nozzle, and a data storage device disposed in the consumable cartridge. The data storage device includes instructions for adjusting one or more operating parameters of the plasma arc torch based on a thickness of the arc transition component along the longitudinal axis.

In yet another aspect, a computer-implemented method is provided for automatically operating a gas-cooled plasma arc torch. The method includes causing, by a computing device, the plasma arc torch to generate a first pilot arc, moving, by the computing device, the plasma arc torch to a location in proximity to a workpiece such that the first pilot arc transfers to the workpiece to form a transferred arc, and causing, by the computing device, the plasma arc torch to process the workpiece with the transferred arc. The method also includes moving, by the computing device, the plasma arc torch to a second location that is distanced from the workpiece such that the transferred arc transitions from the workpiece back to the plasma arc torch to form a second pilot arc. The second pilot arc is adapted to attach to an arc transition component disposed on a distal tip of a nozzle of the plasma arc torch, the arc transition component comprising a noble metal. The method further includes maintaining, by the computing device, the second pilot arc of the plasma arc torch for at least about 3 seconds. In some embodiments, the second pilot arc of the plasma arc torch is maintained for about 5 seconds and can be as long as about 20 seconds.

In some embodiments, the method further includes receiving, by the computing device, data for controlling the plasma arc torch and data for a part to be processed from the workpiece by the plasma arc torch. In some embodiments, the method further includes causing, by the computing device, the plasma arc torch to repeatedly generate a sequence of the first pilot arc, the transferred arc and the second pilot arc at a plurality of locations of the workpiece without plasma arc extinguishment.

In yet another aspect, a computer-implemented method is provided for operating a plasma arc torch on a trimming robot in a plasma arc processing system. The method includes receiving, by a computing device, data for a desired part to be processed from a workpiece and data for the plasma arc torch. The plasma arc torch includes a composite nozzle comprising a nozzle body coupled to an arc transition component made from a material including a noble metal. The arc transition component is disposed on a distal end of the nozzle body. The method also includes causing, by the computing device, the plasma arc torch to generate a pilot arc, and actuating, by the computing device, the plasma arc torch via the trimming robot to trace a path relative to the workpiece in accordance with the workpiece data without piercing the workpiece while the plasma arc torch maintains the pilot arc. The method further includes moving, by the computing device, the plasma arc torch to be in proximity to the workpiece such that the pilot arc is transferred to the workpiece to form a transferred arc that processes the workpiece, and causing, by the computing device, the transferred arc to reattach to the plasma arc torch at the arc transition component of the plasma arc torch to reform the pilot arc.

In some embodiments, causing the transferred arc to reattach to the plasma arc torch comprises distancing the plasma arc torch from the workpiece to eliminate proximity to the workpiece. In some embodiments, the method further includes automatically sensing proximity of the plasm arc torch to the workpiece such that the transferred arc between the plasma arc torch and the workpiece is established automatically once proximity is achieved. In some embodiments, the method further includes maintaining, by the plasma arc torch, the pilot arc for at least about 5 seconds while the plasma arc torch traces the path relative to the workpiece without piercing through the workpiece. In some embodiments, the method further includes further comprising repeatedly toggling, by the plasma arc torch, between generating the pilot arc and the transferred arc for at least 90 seconds without plasma arc extinguishment. In some embodiments, the transferred arc processes the workpiece by piercing through the workpiece to trim casting flash from the workpiece.

In yet another aspect, a method of manufacturing a nozzle for a gas-cooled plasma arc torch is provided. The method includes forming a nozzle body from a first metal. The nozzle body comprises a proximal portion and a distal portion extending along a longitudinal axis. The distal portion of the nozzle body comprises a first bore. The method also includes forming an arc transition component from a second metal. The arc transition component comprises a second bore. The second metal of the arc transition component comprises a noble metal and the second metal is different from the first metal. The method further includes coupling the arc transition component to the distal portion of the nozzle body such that the second bore substantially aligns with the first bore.

Any of the above aspects can include one or more of the following features. In some embodiments, the arc transition component is disposed on a nozzle body of the nozzle, and the arc transition component and the nozzle body are formed from different materials. In some embodiments, the second metal of the arc transition component comprises a noble metal. In some embodiments, the noble metal of the arc transition component is silver. In some embodiments, the noble metal of the arc transition component is gold. In some embodiments, the second metal of the arc transition component comprises at least about 45% silver. For example, the second metal of the arc transition component comprises at least about 85% silver. In some embodiments, the second metal of the arc transition component is a silver alloy. In some embodiments, the silver alloy is silver nickel. In some embodiments, the silver alloy is silver tin oxide. In some embodiments, the silver alloy is silver tungsten oxide. In some embodiments, a material of the nozzle body is copper.

In some embodiments, the arc transition component reduces oxidation on the nozzle from plasma arc attachment, thereby extending duration of one or more pilot arc operations of the plasma arc torch. In some embodiments, the arc transition component includes an external surface comprising a location at which the plasma arc attachment occurs for converting between a transferred plasma arc and a pilot arc. In some embodiments, the arc transition component is coupled to an end face of the distal portion of the nozzle body. The arc transition component can extend within the distal portion of the nozzle body from the end face.

In some embodiments, the arc transition component is at least one of brazed, metallurgically bonded, stamped, frictional welded, swaged, ultrasonically welded or press fit onto the distal portion of the nozzle body. In some embodiments, the arc transition component has a washer-like shape. In some embodiments, the arc transition component comprises a coating on at least one of an end face of the distal portion of the nozzle body, an interior surface of the first bore, or an interior surface of the second bore.

In some embodiments, a thickness of the arc transition component along the longitudinal axis of the nozzle is between about 0.005 inches and about 0.15 inches. For example, the thickness is about 0.06 inches. In some embodiments, a diameter of an end face of the arc transition component is about the same as or smaller than a diameter of an end face of the distal portion of the nozzle body.

In some embodiments, the nozzle is a part of a consumable cartridge configured to be installed in the plasma arc torch. In some embodiments, the consumable cartridge includes a data storage device configured to store instructions for adjusting one or more operating parameters of the plasma arc torch based on a thickness of the arc transition component. In some embodiments, the one or more operating parameters comprise a piloting profile. In some embodiments, the one or more operating parameters include at least one of gas pressure, gas selection, process identification, cut speed, amperage, piloting profiles, ramping profiles, or system compensation in view of usage. In some embodiments, the data storage device is a radio-frequency identification tag or a security chip.

In some embodiments, the nozzle is configured to operate at a current level below about 140 amps. In some embodiments, the nozzle includes a contact start surface disposed on an interior surface of the nozzle body proximate to the distal portion. The contact start surface is configured to contact the electrode during arc generation. In some embodiments, the electrode is a contact-start electrode configured to contact the nozzle during initiation of a pilot arc. In some embodiments, the electrode is disposed within the nozzle body of the nozzle.

In some embodiments, the plasma arc torch is mounted on a robotic arm that is controlled by the computing device.

It should also be understood that various aspects and embodiments of the invention can be combined in various ways. Based on the teachings of this specification, a person of ordinary skill in the art can readily determine how to combine these various embodiments. For example, in some embodiments, any of the aspects above can include one or more of the above features. One embodiment of the invention can provide all of the above features and advantages.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary nozzle configured for installation in a plasma arc torch, according to some embodiments of the present invention.

FIG. 2 shows an exemplary exploded view of the nozzle of FIG. 1, according to some embodiments of the present invention.

FIG. 3 shows a perspective view of the assembled nozzle of FIGS. 1 and 2, according to some embodiments of the present invention.

FIG. 4 shows a sectional view of another exemplary nozzle configured for installation in a plasma arc torch, according to some embodiments of the present invention.

FIG. 5 shows a perspective view of the nozzle of FIG. 4, according to some embodiments of the present invention.

FIG. 6 shows an exemplary consumable cartridge that incorporates the nozzle of FIGS. 4 and 5, according to some embodiments of the present invention.

FIG. 7 shows an exemplary plasma arc processing system having a plasma arc torch that incorporates the nozzle of FIGS. 1-3 or the nozzle of FIGS. 4 and 5, according to some embodiments of the present invention.

FIGS. 8a-d show performance comparisons between traditional nozzles and the nozzle of FIGS. 1-3 after varying periods of use, according to some embodiments of the present invention.

FIG. 9 shows an exemplary computer-implemented process used by the plasma arc processing system of FIG. 7 for automatically operating the plasma arc torch, according to some embodiments of the present invention.

### DETAILED DESCRIPTION

FIG. 1 shows an exemplary nozzle 100 configured for installation in a plasma arc torch, according to some embodiments of the present invention. The plasma arc torch can be a gas-cooled, contact start plasma arc torch. Alternatively, the plasma arc torch can be cooled by one or more of air or a liquid coolant (e.g., water) and optionally with a high-frequency start mechanism. As shown, the nozzle 100 includes a nozzle body 102 having a proximal portion 104 and a distal portion 106 extending along a longitudinal axis A. The distal portion 106 is generally defined as the section of the nozzle body 102 that is closest to a workpiece during operation of the torch, and the proximal portion 104 is located opposite of the distal portion 106 along the longitudinal axis A. The distal portion 106 includes a bore 108. A contact start surface 109 is disposed on an interior surface of the nozzle body 102 proximate to the distal portion 106, where the contact start surface 109 is configured to physically contact an electrode (not shown) during plasma arc generation. The nozzle 100 further includes an arc transition component 110 configured to be coupled to the distal portion 106 of the nozzle body 102. For example, the arc transition component 110 can be coupled to an end face 116 of the distal portion 106 of the nozzle body 102. The arc transition component 110 also includes a bore 112 that is configured to substantially align with the bore 108 of the nozzle body 102 when the arc transition component 110 is coupled to the nozzle body 102.

In some embodiments, the material of the arc transition component 110 is selected to minimize arc erosion. Such a material is electrically conductive, does not form an oxide susceptible to spalling off, facilitates rapid arc movement to distribute heat, and minimizes arc erosion. In some embodiments, both the nozzle body 102 and the arc transition component 110 are made from metals (i.e., electrically conductive materials), but the metal of the nozzle body 102 is different from that of the arc transition component 110. In some embodiments, the metal of the arc transition component 110 comprises a noble metal, such as silver or gold. In some embodiments, the metal of the arc transition component 110 is an arc-resistant alloy or composite, such as a noble metal-based alloy or composite. For example, the arc transition component 110 can be a silver alloy/composite, such as silver nickel (Ag/Ni) (e.g., about 90% silver and about 10% nickel, or about 85% silver and about 15% nickel), silver cadmium oxide (Ag/CdO), silver tin oxide (Ag/SnO₂) (e.g., about 88% silver and about 12% tin oxide, or about 86% silver and about 14% tin oxide), silver Molybdenum (Ag/Mo), silver tungsten (Ag/W), silver tungsten oxide, silver graphite (Ag/C), powder metallurgical silver tin-oxide doped with tungsten oxide (Ag/SnO₂/SPW4), silver tungsten graphite (Ag/W/C) or silver tungsten graphite with tungsten oxide (Ag/W/C/SPW4). In some embodiments, the arc transition component 110 includes at least about 45% of a noble metal, such as at least about 45% silver, about 80% silver, or about 85% silver. In some embodiments, the metal of the arc transition component 110 is a pure noble metal. The inclusion of a noble metal material proximate (e.g., on) the tip of the nozzle 100 is adapted to increase the operable life of the nozzle 100 as well as increase long-term cutting accuracy and precision of torch consumables. In some embodiments, the metal of the arc transition component 110 is or includes titanium. In some embodiments, the metal of the nozzle body 102 is copper or a copper alloy. In some embodiments, the nozzle body 102 and the arc transition component 110 are made from the same metal, such as a metal comprising a noble metal (e.g., silver, gold or silver nickel). In some embodiments, the nozzle 100 is a single/monolithic component made from a single material that includes a noble metal (e.g., a silver alloy/composite).

In some embodiments, different materials are selected for the arc transition component 110 to combat wear for different plasma arc torches and/or operations, as they can degrade the nozzle in different ways. For example, a plasma arc torch with a high gas flow and high pilot current may benefit from an arc transition component 110 being made from a low arc erosion material (e.g., pure silver or silver cadmium alloys) in comparison to a plasma arc torch with a low gas flow and low pilot current that may benefit from the arc transition component 110 being made from a material with high arc spot mobility (e.g., an alloy of about 90% silver and about 10% nickel). High arc spot mobility is desirable because it allows plasma arc to attach at different locations around the nozzle bore to distribute the thermal load. These multiple attachment points thus prevent the plasma arc from eroding one particular nozzle location. In some embodiments, the nozzle 100 is configured to operate at a current level below about 140 amps.

In addition to material composition, the location of the arc transition component 110 within the nozzle 100 can also be chosen to reduce oxidation on the nozzle 100 from plasma arc attachment, thereby extending the duration of one or more pilot arc operations by the plasma arc torch as well as extending the life of the nozzle. More specifically, as shown in FIG. 1, the arc transition component 110, which comprises an arc-erosion resistant material (e.g., a noble-metal-based alloy), is disposed proximate to the distal portion 106 of the nozzle body 102 (e.g., defining a portion of the distal tip of the nozzle 100) at a location where the arc is likely to terminate during the pilot arc mode and cause erosion of the nozzle. In particular, the arc transition component 110 can include an external surface 114 that forms a location (i.e., the anode) at which the plasma arc attachment occurs for converting between a transferred plasma arc and a pilot arc during torch operation. Such arc attachment can cause the external surface 114 to heat to temperatures exceeding about 550 Celsius. Thus, selecting the right material to form the arc transition component 110 can provide arc-erosion/wear resistance at that location during torch operations. In addition, the arc-erosion/wear resistant material of the arc transition component 110 is adapted to line a portion of the bore of the nozzle 100, which further promotes arc durability. Overall, the arc transition component 110, which is disposed in and/or around the bore 108 of the nozzle body 102, is adapted to improve conduction of heat from the bore 108 and/or reduce oxidation on the nozzle 100 from arc attachment, particularly during pilot arc operations.

As described above, the multi-material nozzle 100 of FIG. 1 is a composite of the nozzle body 102 and the arc transition component 110 with two or more dissimilar metals (e.g., copper and a silver alloy) joined together. In some embodiments, the arc transition component 110 is at least one of brazed, metallurgically bonded, stamped, swaged, friction welded, induction heat welded, ultrasonically welded or press fit, crimp fit, or pressed and diffused onto the distal portion 106 of the nozzle body 102. In some embodiments, the arc transition component 110 has a washer-like shape with the bore 112 extending through the center of the washer, as shown in FIG. 1. In some embodiments, the arc transition component 110 is applied as a coating on at least one of the end face 116 of the distal portion 106 of the nozzle body 102 or an interior surface of the bore 108 of the nozzle body 102. In some embodiments, the thickness 118 of the arc transition component 110 along the longitudinal axis A of the nozzle 100 is between about 0.005 inches and about 0.15 inches. For example, the thickness 118 can be about 0.06 inches. In some embodiments, the diameter of the external surface 114 of the arc transition component 110 is about the same as or smaller than the diameter of the end face 116 of the distal portion 106 of the nozzle body 102.

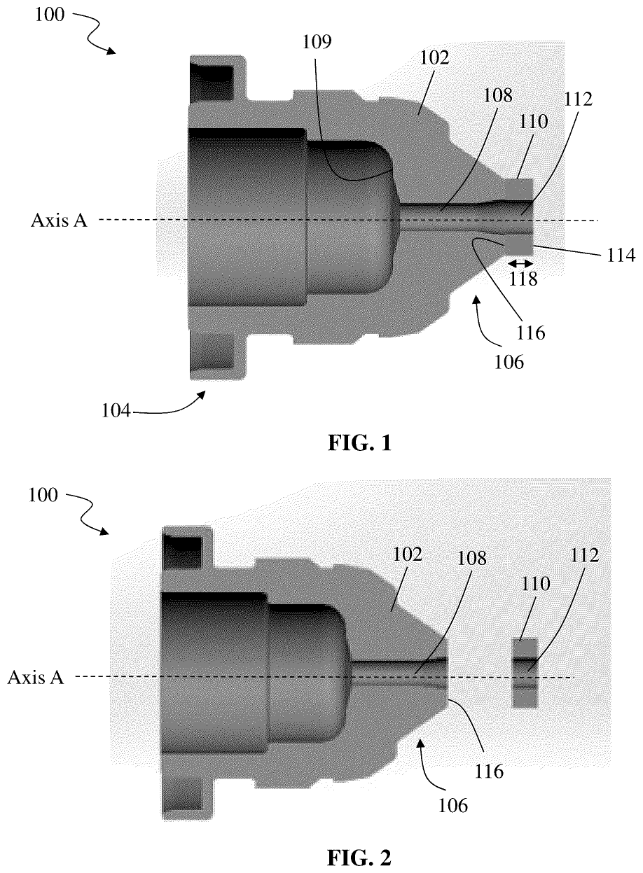

FIG. 2 shows an exemplary exploded view of the nozzle 100 of FIG. 1, according to some embodiments of the present invention. The nozzle body 102 can be machined from a metal, such as copper, with the central bore 108 extending therethrough. The arc transition component 110 can be formed in the shape of a washer with the central bore 112 extending therethrough. The arc transition component 110 can be manufactured via stamping/machining from any of the materials described above (e.g., a silver-based material/alloy) that is different from the material of the nozzle body 102 (e.g., copper). The arc transition component 110 is then coupled to the end face 116 of the distal portion 106 of the nozzle body 102 where the pilot arc commonly attaches, while the two bores 108, 112 are substantially aligned. The arc transition component 110 can be brazed onto the nozzle body 102 to achieve fixed attachment. In some embodiments, the arc transition component 110 includes a built-in brazing material. In some embodiments, brazing is performed in argon atmosphere for about 25 seconds with power at about 75%. In some embodiments, brazing is performed in air or in inert or hydrogen atmosphere at a temperature of between about 651 Celsius and about 895 Celsius.

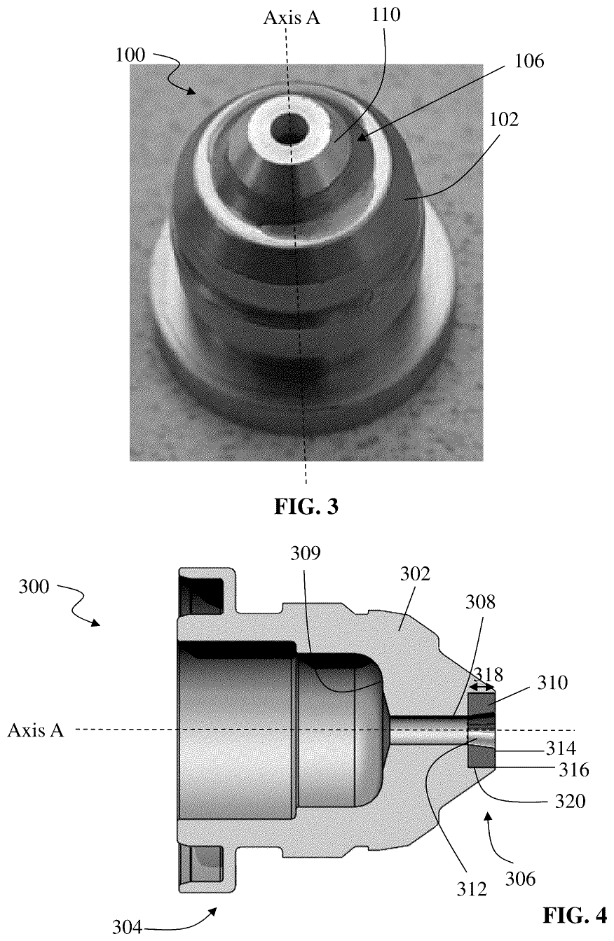

FIG. 3 shows a perspective view of the assembled nozzle 100 of FIGS. 1 and 2, according to some embodiments of the present invention. As shown, the arc transition component 110 is disposed at the end face 116 of the distal portion 106 of the nozzle body 102 and is contoured to complement the shape of the distal portion 106. The composite of the arc transition component 110 and the nozzle body 102 is adapted to form the nozzle 100 of a gas-cooled plasma arc torch.

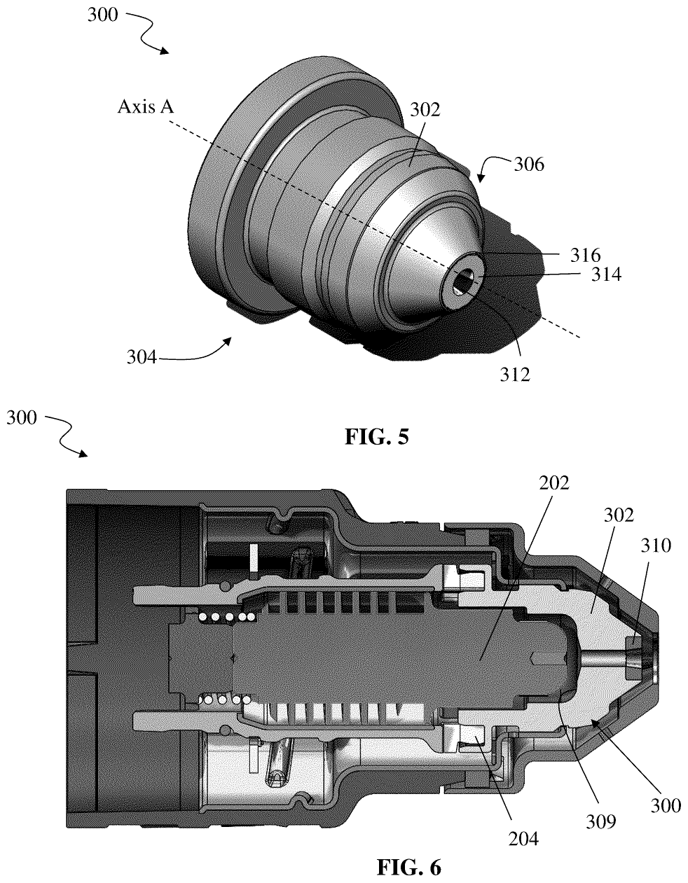

FIGS. 4 and 5 show a sectional view and a perspective view, respectively, of another exemplary nozzle 300 configured for installation in a plasma arc torch, according to some embodiments of the present invention. The nozzle 300 of FIGS. 4 and 5 is a multi-material composite nozzle that is similar in construction and composition to the nozzle 100 of FIGS. 1-3. As shown, the nozzle 300 includes a nozzle body 302 comprising a proximal portion 304 and a distal portion 306 extending along a longitudinal axis A. The distal portion 306 of the nozzle body 302 includes a bore 308. A contact start surface 309 is disposed on an interior surface of the nozzle body 302 proximate to the distal portion 306. The nozzle body 302 can have the same material composition as the nozzle body 102 of nozzle 100 described above, such as copper or a copper alloy. The nozzle 300 further includes an arc transition component 310 configured to be coupled to the distal portion 306 of the nozzle body 302. As shown, the arc transition component 310 can be disposed within a cavity 320 machined into the nozzle body 302 from the end face 316 of the distal portion 306 of the nozzle body 302. The arc transition component 310 also includes a bore 312 that is configured to substantially align with the bore 308 of the nozzle body 302 when the arc transition component 310 is coupled to the nozzle body 302.

In some embodiments, the arc transition component 310 is coupled to the nozzle body 302 by squeezing and/or crimping into the cavity 320. In some embodiments, the arc transition component 310 has the same material composition as the arc transition component 110 of nozzle 100 described above, such as a material that includes a noble metal (e.g., silver or a silver alloy). In some embodiments, the thickness 318 of the arc transition component 310 along the longitudinal axis is substantially the same as the thickness 118 of the arc transition component 110 of nozzle 100 (e.g., between about 0.005 inches and about 0.15 inches). In the nozzle configuration of FIGS. 4 and 5, the external surface face 314 of the arc transition component 310 is substantially aligned with/flush against the end face 316 of the nozzle body 302. The diameter of the external surface 314 of the arc transition component 310 can be smaller than the diameter of the end face 316 of the distal portion 306 of the nozzle body 302.

In another aspect, the nozzle 100 of FIGS. 1-3 or the nozzle 300 of FIGS. 4 and 5 can form a part of a consumable cartridge of a plasma arc torch, where the cartridge includes two or more consumable components encapsulated as a single unit. A consumable cartridge is defined herein as a unitary component where the components of the cartridge are not individually serviceable or disposable. Thus, if one component of the consumable cartridge needs to be replaced, the entire cartridge is replaced. In some embodiments, the consumable cartridge is a “single use” cartridge, where the cartridge is replaced by the operator after any of its components reaches the end of its service life rather than repairing and replacing the individual components like in traditional torch designs. Since the usage of the multi-material composite nozzle 100 or 300 generally prolongs nozzle life in comparison to a traditional nozzle, as explained above, incorporating such a nozzle design into a consumable cartridge is adapted to improve cartridge life as well as cut quality. FIG. 6 shows an exemplary consumable cartridge 200 that incorporates the multi-material composite nozzle 300 of FIGS. 4 and 5, according to some embodiments of the present invention. In alternative embodiments, the cartridge 200 is easily configured to incorporate the multi-material composite nozzle 100 of FIGS. 1-3. As shown, the consumable cartridge 200 also includes an electrode 202 disposed within a portion of the interior region of the nozzle body 102 or 302 of the nozzle 300. In addition, the consumable cartridge 200 includes a swirl ring 204 disposed about an exterior surface the electrode 202 and fixedly connected to the nozzle 300. The electrode 202 can be a contact start electrode that is adapted to physically contact the interior contact start surface 309 of the nozzle body 302 during initiation of a pilot arc.

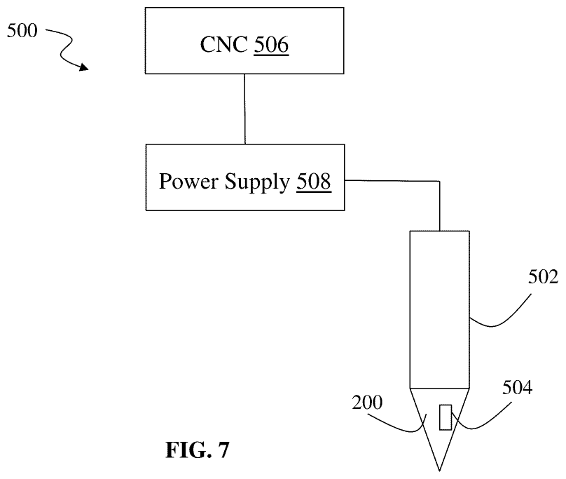

FIG. 7 shows an exemplary plasma arc processing system 500 having a plasma arc torch 502 that incorporates the multi-material composite nozzle 100 of FIGS. 1-3 or the multi-material composite nozzle 300 of FIGS. 4 and 5, according to some embodiments of the present invention. The plasma arc torch 502 is a gas-cooled, contact-start plasma arc torch configured to operate in a pilot arc mode (for initiating/igniting a plasma arc) or a transferred arc mode (for processing a workpiece by transferring the plasma arc to the workpiece). In some embodiments, the plasma arc torch 502 includes the consumable cartridge 200 of FIG. 6, in which case the nozzle 100 or 300 is a part of the cartridge 200 as described above. Alternatively, the nozzle 100 or 300 can be installed inside of the torch 502 without being a part of a consumable cartridge, in which case the nozzle 100 or 300 is individually serviceable and changeable. The plasma arc torch 502 can further include at least one data storage device 504 configured to store data (e.g., instructions) about the nozzle 100 or 300 that is usable by the plasma arc torch system 500 to adjust one or more operating parameters of the plasma arc torch 502. The data storage device 504 can be a radio-frequency identification (RFID) tag, a memory device, or a security chip (e.g., a printed circuit board with process data embedded therein, such as identification and operational data). The data storage device 504 can be disposed within or on the body of the nozzle 100 or 300 or coupled to another consumable component inside of the torch 502. If cartridge 200 is installed within the torch 502, the data storage device 504 can be incorporated within the cartridge 200 along with the nozzle 100 or 300.

In some embodiments, the data storage device 504 is in electrical communication with a computer numeric controller (CNC) 506 of the plasma are material processing system 500, where the CNC 506 is configured to automatically control operations of the plasma are torch 502. Data from the data storage device 504 can be electrically communicated to the CNC 506. For example, if the data storage device 504 is an RFID tag, the plasma arc processing system 500 can include an RFID reader (not shown) configured to receive data in the form of radio-frequency signals from the data storage device 504. The nozzle data stored in the storage device 504 can include, for example, at least one of the thickness 118 or 318 of the arc transition component 110 or 310 of the nozzle 100 or 300, or the type/composition of the nozzle 100 or 300. In some embodiments, the CNC 506 can receive the nozzle data via input from an operator, if, for example, a data storage device is absent from the system 500. Based on the nozzle data, the CNC 506 can send control commands to a power supply 508 of the plasma arc processing system 500 to operate the plasma arc torch 502 in conditions specific to the nozzle 100 or 300 and/or cartridge 200 (if the cartridge is installed inside of the torch 502). These control commands can include settings for one or more operating parameters comprising at least one of gas pressure, gas selection, process identification, cut speed, amperage, piloting profile, ramping profile, standoff distance, or system compensation in view of usage. As an example, the value of an “expected pilot life” parameter (representing a piloting profile) for the plasma arc torch 502 can be automatically set by the CNC 506 based on the type of the nozzle incorporated in the cartridge. For a cartridge with a standard nozzle (e.g., constructed from a single metal), the expected pilot life can be set to 5 minutes. In contrast, for a cartridge with the multi-material composite nozzle 100 or 300, the expected pilot life is about 5 to 10 times longer than that of the standard nozzle. During torch operation, if the duration of a piloting operation is much less than the expected pilot life value, this indicates to the operator that the nozzle 100 or 300 (or cartridge 200 if it is installed inside of the torch 502) is in operable condition. However, if the duration of the piloting operation is closer to or larger than the expected pilot life value, this indicates to the operator that the nozzle 100 or 300 (or cartridge 200 if it is installed inside of the torch 502) needs to be replaced for optimal cutting performance. In other exemplary configurations, nozzles can have alloy compositions designed/selected for one or more of a higher stand-off, higher current and/or gas flow, or lower current and/or gas flow. Nozzle ID can also drive these selections. In yet another example, the CNC 506 can increase pilot life linearly with the thickness 118 or 318 of the arc transition component 110 or 310. For instance, if the arc transition component 110 or 310 has a thickness 118 or 318 of about 0.060 inches, this provides about 5-10 times longer pilot life than a traditional single-material nozzle. If the arc transition component 110 or 310 has a thickness 118 or 318 of about 0.0120 inches, this increases pilot life another 3-5 times.

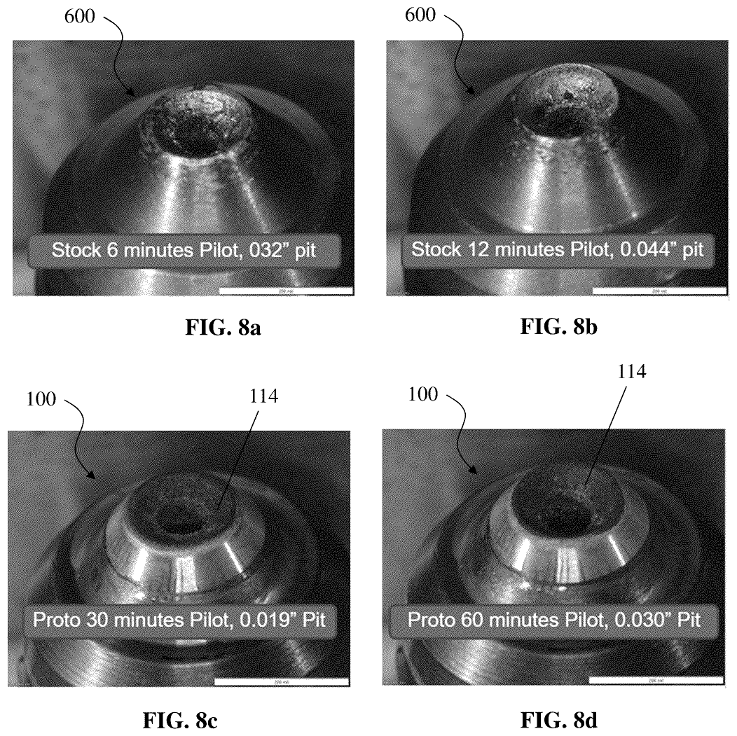

Incorporating the multi-material composite nozzle 100 of FIGS. 1-3 or the multi-material composite nozzle 300 of FIGS. 4 and 5 inside of a plasma arc torch (e.g., torch 502 of FIG. 7), either as a part of a consumable cartridge (e.g., consumable cartridge 200 of FIG. 6) or a stand-alone consumable, is adapted to increase the cutting life of the torch due to the arc erosion resistant properties of the nozzle 100 or 300. Such a torch design is particularly valuable in robotic applications where the pilot arc is used as a sensor to detect and/or respond to the presence of material to cut and quickly transition to a transferred arc. By reducing operation stoppage for consumable changes and minimizing poor cut qualities, this nozzle design can significantly improve production efficiency. FIGS. 8a-d show performance comparisons between traditional nozzles 600 and the multi-material composite nozzle 100 of FIG. 1 after varying periods of use, according to some embodiments of the present invention. In particular, FIGS. 8a and b show the distal portions of traditional nozzles 600 after about 6 minutes and 12 minutes, respectively, of operating in a pilot arc mode. The traditional nozzles 600 are constructed from a single material of copper. The average depth of pits formed on the traditional nozzle 600 after about 6 minutes of pilot operation (illustrated in FIG. 8a) is about 0.032 inches, and the average depth of pits for the traditional nozzle 600 after about 12 minutes of pilot operation (illustrated in FIG. 8b) is about 0.044 inches. In contrast, FIGS. 8c and d show the distal portions of the composite nozzles 100 after about 30 minutes and 60 minutes, respectively, of operating in a pilot arc mode, where the average depth of pits are about 0.019 inches and 0.030 inches, respectively. Therefore, the multi-material composite nozzles 100 have reduced pitting on and/or erosion of the nozzle end face 114 at which arcs attach, thereby increasing nozzle life by 3, 4, or even 5 times compared to the standard all-copper nozzles 600. More particularly, the use of the arc transition component 110 in the nozzle 100 improves consumable life and cut quality. In addition, the composite nozzle design 300 of FIGS. 4 and 5 offer superior performance in comparison to traditional nozzles, similar to that of nozzle 100.

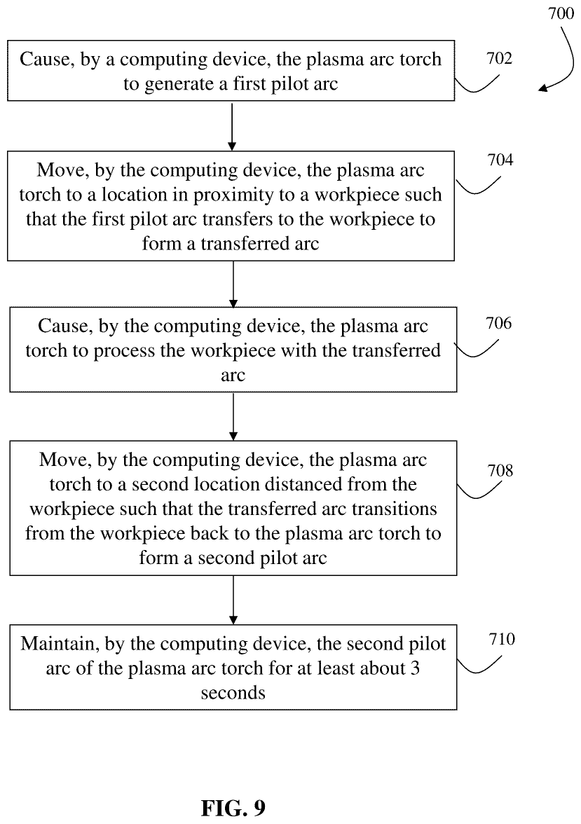

FIG. 9 shows an exemplary computer-implemented process 700 used by the plasma arc processing system 500 of FIG. 5 for automatically operating the gas-cooled plasma arc torch 502 (e.g., in a robotics operation), according to some embodiments of the present invention. The multi-material composite nozzle 100 of FIGS. 1-3 or the multi-material composite nozzle 300 of FIGS. 4 and 5 can be installed inside of the torch 502 as, for example, a part of a consumable cartridge (e.g., cartridge 200 of FIG. 6) or a stand-alone component. In some embodiments, the plasma arc torch 502 is mounted on a robotic arm (not shown) of the plasma arc processing system 500 that is controlled by the CNC 506 using the process 700 of FIG. 9.

As shown, at step 702 of process 700, the CNC 506 of the plasma arc processing system 500 can actuate the torch 502 to generate a pilot arc in preparation for processing a workpiece. At step 704, the CNC 506 can move the torch 502 to a location in proximity to the workpiece such that the pilot arc is adapted to transfer to the workpiece to form a transferred arc that processes (e.g., cuts, gouges, or marks) the workpiece at step 706. In some embodiments, the transfer of the arc to the workpiece is automatic once the torch tip is at sufficient proximity (e.g., vertical or lateral) to the workpiece to establish a path of least resistance to the workpiece. After the desired processing is completed at that particular location, at step 708, the CNC 506 can move/translate the torch 502 to another location relative to the workpiece at which the torch 502 is distanced from workpiece such that the transferred arc transitions from the workpiece back to the plasma arc torch 502 to form another pilot arc. In some embodiments, the transition of the arc back to the torch 502 is automatic once the torch tip is at a sufficient distance from the workpiece that the path of least resistance is the torch 502 itself. This distancing can be achieved by at least one of the CNC 506 lifting the torch 502 away from the workpiece, the CNC 506 laterally moving the torch along the workpiece such that the torch tip is distanced from the workpiece, and/or the torch 502 being at a location where the workpiece is distant from the torch (e.g., a hole or unevenness in the workpiece). As described above, the distancing is adapted to cause the pilot arc to attach to the end face 114 or 314 of the arc transition component 110 or 310 of the nozzle 100 or 300. However, due to the material composition of the arc transition component 110 or 310 (e.g., incorporating a noble metal, such as silver), the nozzle 100 or 300 is less vulnerable to arc wear/erosion in comparison to a traditional nozzle. At step 710, the CNC 506 is configured to maintain the pilot arc (from step 708) for a duration, such as 3 seconds or greater (e.g., at least 5 seconds and/or as long as about 20 seconds). In some embodiments, while the pilot arc is maintained, the CNC 506 can repeat process 700 by moving the torch 502 to a different location on the workpiece and processing the workpiece at the new location without extinguishing the plasma arc. Thus, the plasma arc torch 502 can be actuated to repeatedly generate a sequence of pilot arcs and transferred arcs at multiple locations of the workpiece without plasma arc extinguishment.

In some embodiments, the CNC 506 automatically controls the plasma arc torch 502 using at least one of data input by an operator or data received from the data storage device 504 disposed in the torch 502, as described above with reference to FIG. 7. The data can include data for the desired part(s) to be processed from the workpiece, values of various operating parameters for controlling the torch 502, as well as information that is usable by the CNC 506 to automatically adjust these operating parameters (e.g., the thickness of the arc transition component 110 or 310, the material composition of the nozzle 100 or 300, etc.).

In some embodiments, the process 700 of FIG. 9 is tailored for cast trimming operations, in which case the robotic arm on which the torch 502 is mounted can be a trimming robot. In an exemplary cast trimming operation, after the initial pilot arc is generated at step 702, the CNC 506 can actuate the torch 502 via the trimming robot to trace a desired path on the workpiece in accordance with the workpiece data. Tracing typically involves translating the torch 502 around the outline of a cast, outlining the desired shape that is supposed to be cast, during which the pilot arc generated by the torch is adapted to quickly transfer to the workpiece when the pilot arc gets within a proximity to the workpiece and remove/trim any undesired flashing on the perimeter of the desired part/cast via transferred arc. The proximity to the workpiece can be between about 0.05 inches and about 2.5 inches, such as between about 0.15 inches and about 1.5 inches, and more specifically between about 0.4 inches and about 1.2 inches. In some embodiments, the proximity distance for a cutting operation is between about 0.01 inches and 2 inches. An exemplary height for cutting is about 0.06 inches to about 0.18 inches. An exemplary height for fine cutting is about 0.01 inches to about 0.06 inches. The proximity distance for a gouging operation is between about 0.1 inches and about 4 inches. During the tracing, the pilot arc can be maintained by the torch 502 between 0 to about 30 seconds (e.g., about 5 seconds) before extinguishment. In an exemplary operation, as the CNC 506 executes step 704 by moving the torch 502 to trace the workpiece, when the torch 502 is in proximity to the workpiece (e.g., encounters an undesired flash section), the pilot arc is automatically transferred to the workpiece to form a transferred arc that processes the workpiece (step 706). More particularly, such processing performed in the context of the trimming operation involves the transferred arc edge starting to trim casting flash from the workpiece along the tracing path. The CNC 506 can sense the proximity of the plasm arc torch 502 to the workpiece such that the transferred arc between the plasma arc torch 502 and the workpiece is automatically established once proximity is achieved. This can be accomplished when the torch 502 gets close enough to the workpiece that the arc automatically jumps to the workpiece to adjust its path of resistance, in which case the pilot arc transitions to a transferred arc. As the CNC 506 continues to actuate the torch 502 to move/translate along the trace path over the workpiece, when the torch 502 encounters a section where the torch 502 is distant from the workpiece (e.g., where there is no undesired flash underneath the workpiece), proximity to the workpiece is eliminated and the transferred arc is reattached to the plasma arc torch at the arc transition component 110 or 310 of the plasma arc torch 100 or 300, thereby reforming a pilot arc (step 708). In some embodiments, the distancing is realized when moving the torch 502 along the trace/path of the anticipated edge of the cast/desired part and flashing is absent, in which case the arc becomes too far to extend to the workpiece so that the arc retreats to the nozzle and the torch 502 automatically enters pilot mode until flashing gets close enough for the arc to jump again to the workpiece. In some embodiments, the torch 502 repeatedly toggles between generating the pilot arc and the transferred arc for casting trimming purposes along a trace path for at least 90 seconds without plasma arc extinguishment (step 710). In some embodiments, the CNC 506/power supply 508 automatically detects whether the torch is operating in the transferred arc mode or the pilot arc mode and can adjust the current and gas supplied to the torch 502 accordingly. In some embodiments, the system performs such mode detection based on the amount of current that goes through the workpiece. For example, if the system senses that the current going through the workpiece is about zero, it indicates that the torch 502 is in pilot arc mode. In contrast, if the system senses that the current going through the workpiece is higher than about 0.4 amps, it indicates that the torch 502 is in transferred arc mode. If pilot arc mode is detected, the CNC 506/power supply 508 can automatically ramp down the gas and current supplied to the torch 502. Conversely, if transferred arc mode is detected, the CNC 506/power supply 508 can automatically ramp up the gas and current supplied to the torch 502.

It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A nozzle for a gas-cooled plasma arc torch, the nozzle comprising:
a nozzle body formed from a first metal, the nozzle body comprising a proximal portion and a distal portion extending along a longitudinal axis, wherein the distal portion of the nozzle body comprises a first bore; and
an arc transition component formed from a second metal, the arc transition component coupled to the distal portion of the nozzle body and comprising a second bore configured to substantially align with the first bore when the arc transition component is coupled to the nozzle body,
wherein the second metal of the arc transition component comprises a noble metal and the second metal is different from the first metal.

2. The nozzle of claim 1, wherein the noble metal of the arc transition component is silver.

3. The nozzle of claim 1, wherein the noble metal of the arc transition component is gold.

4. The nozzle of claim 2, wherein the second metal of the arc transition component is a silver alloy.

5. The nozzle of claim 1, wherein the second metal of the arc transition component comprises at least about 45% silver.

6. The nozzle of claim 5, wherein the second metal of the arc transition component comprises at least about 85% silver.

7. The nozzle of claim 4, wherein the silver alloy is silver nickel.

8. The nozzle of claim 4, wherein the silver alloy is silver tin oxide.

9. The nozzle of claim 4, wherein the silver alloy is silver tungsten oxide.

10. The nozzle of claim 1, wherein the arc transition component reduces oxidation on the nozzle from plasma arc attachment, thereby extending duration of one or more pilot arc operations of the plasma arc torch.

11. The nozzle of claim 10, wherein the arc transition component includes an external surface comprising a location at which the plasma arc attachment occurs for converting between a transferred plasma arc and a pilot arc.

12. The nozzle of claim 1, wherein the arc transition component is coupled to an end face of the distal portion of the nozzle body.

13. The nozzle of claim 12, wherein the arc transition component extends within the distal portion of the nozzle body from the end face.

14. The nozzle of claim 1, wherein the arc transition component is at least one of brazed, metallurgically bonded, stamped, frictional welded, swaged, ultrasonically welded, diffusion bonded, or press fit onto the distal portion of the nozzle body.

15. The nozzle of claim 1, wherein the arc transition component has a washer-like shape.

16. The nozzle of claim 1, wherein the arc transition component comprises a coating on at least one of an end face of the distal portion of the nozzle body, an interior surface of the first bore, or an interior surface of the second bore.

17. The nozzle of claim 1, wherein a thickness of the arc transition component along the longitudinal axis of the nozzle is between about 0.005 inches and about 0.15 inches.

18. The nozzle of claim 17, wherein the thickness is about 0.06 inches.

19. The nozzle of claim 1, wherein a diameter of an end face of the arc transition component is about the same as or smaller than a diameter of an end face of the distal portion of the nozzle body.

20. The nozzle of claim 1, wherein the nozzle is a part of a consumable cartridge configured to be installed in the plasma arc torch.

21. The nozzle of claim 20, wherein the consumable cartridge includes a data storage device configured to store instructions for adjusting one or more operating parameters of the plasma arc torch based on a thickness of the arc transition component.

22. The nozzle of claim 21, wherein the one or more operating parameters comprises a piloting profile.

23. The nozzle of claim 1, wherein the nozzle is configured to operate at a current level below about 140 amps.

24. The nozzle of claim 1, further comprising a contact start surface disposed on an interior surface of the nozzle body proximate to the distal portion, the contact start surface configured to contact the electrode during arc generation.

25. A consumable cartridge for a gas-cooled plasma arc torch, the consumable cartridge comprising:
a composite nozzle comprising a nozzle body formed from a first metal and an arc transition component formed from a second metal different from the first metal, the arc transition component coupled to a distal end of the nozzle body along a longitudinal axis of the nozzle;
an electrode disposed within a portion of the nozzle;
a swirl ring disposed about the electrode and fixedly connected to the nozzle; and
a data storage device disposed in the consumable cartridge, the data storage device including instructions for adjusting one or more operating parameters of the plasma arc torch based on a thickness of the arc transition component along the longitudinal axis.

26. The consumable cartridge of claim 25, wherein the one or more operating parameters include at least one of gas pressure, gas selection, process identification, cut speed, amperage, piloting profiles, ramping profiles, or system compensation in view of usage.

27. The consumable cartridge of claim 25, wherein the electrode is a contact-start electrode configured to contact the nozzle during initiation of a pilot arc.

28. The consumable cartridge of claim 25, wherein the second metal of the arc transition component comprises a noble metal.

29. The consumable cartridge of claim 28, wherein the second metal of the arc transition component comprises at least about 45% silver.

30. The consumable cartridge of claim 25, wherein the data storage device is a radio-frequency identification tag or a security chip.

31. The consumable cartridge of claim 25, wherein the thickness of the arc transition component along the longitudinal axis of the nozzle is between about 0.005 inches and about 0.15 inches.

32. The consumable cartridge of claim 25, wherein the electrode is disposed within the nozzle body of the nozzle.

33. The consumable cartridge of claim 25, wherein the arc transition component includes a location at which a plasma arc attaches for converting between a transferred plasma arc and a pilot arc.

34. A computer-implemented method for automatically operating a gas-cooled plasma arc torch, the method comprising:
causing, by a computing device, the plasma arc torch to generate a first pilot arc;
moving, by the computing device, the plasma arc torch to a location in proximity to a workpiece such that the first pilot arc transfers to the workpiece to form a transferred arc;
causing, by the computing device, the plasma arc torch to process the workpiece with the transferred arc;
moving, by the computing device, the plasma arc torch to a second location distanced from the workpiece such that the transferred arc transitions from the workpiece back to the plasma arc torch to form a second pilot arc, wherein the second pilot arc is adapted to attach to an arc transition component disposed on a distal tip of a nozzle of the plasma arc torch, the arc transition component comprising a noble metal; and
maintaining, by the computing device, the second pilot arc of the plasma arc torch for at least about 3 seconds.

35. The computer-implemented method of claim 34, further comprising receiving, by the computing device, data for controlling the plasma arc torch and data for a part to be processed from the workpiece by the plasma arc torch.

36. The computer-implemented method of claim 34, further comprising causing, by the computing device, the plasma arc torch to repeatedly generate a sequence of the first pilot arc, the transferred arc and the second pilot arc at a plurality of locations of the workpiece without plasma arc extinguishment.

37. The computer-implemented method of claim 34, wherein the arc transition component is disposed on a nozzle body of the nozzle, the arc transition component and the nozzle body are formed from different materials.

38. The computer-implemented method of claim 37, wherein the noble metal of the arc transition component is silver.

39. The computer-implemented method of claim 37, wherein a material of the arc transition component is silver alloy.

40. The computer-implemented method of claim 37, wherein a material of the nozzle body is copper.

41. The computer-implemented method of claim 34, wherein the plasma arc torch is mounted on a robotic arm that is controlled by the computing device.

42. The computer-implemented method of claim 34, wherein the second pilot arc of the plasma arc torch is maintained for about 5 seconds.

43. A computer-implemented method for operating a plasma arc torch on a trimming robot in a plasma arc processing system, the method comprising:
receiving, by a computing device, data for a desired part to be processed from a workpiece and data for the plasma arc torch, wherein the plasma arc torch includes a composite nozzle comprising a nozzle body coupled to an arc transition component made from a material including a noble metal, the arc transition component disposed on a distal end of the nozzle body;
causing, by the computing device, the plasma arc torch to generate a pilot arc;
actuating, by the computing device, the plasma arc torch via the trimming robot to trace a path relative to the workpiece in accordance with the workpiece data without piercing the workpiece while the plasma arc torch maintains the pilot arc;
moving, by the computing device, the plasma arc torch to be in proximity to the workpiece such that the pilot arc is transferred to the workpiece to form a transferred arc that processes the workpiece; and
causing, by the computing device, the transferred arc to reattach to the plasma arc torch at the arc transition component of the plasma arc torch to reform the pilot arc.

44. The computer-implemented method of claim 43, wherein causing the transferred arc to reattach to the plasma arc torch comprises distancing the plasma arc torch from the workpiece to eliminate proximity to the workpiece.

45. The computer-implemented method of claim 43, further comprising automatically sensing proximity of the plasm arc torch to the workpiece such that the transferred arc between the plasma arc torch and the workpiece is established automatically once proximity is achieved.

46. The computer-implemented method of claim 43, wherein the transferred arc processes the workpiece by piercing through the workpiece to trim casting flash from the workpiece.

47. The computer-implemented method of claim 43, further comprising maintaining, by the plasma arc torch, the pilot arc for at least about 5 seconds while the plasma arc torch traces the path relative to the workpiece without piercing through the workpiece.

48. The computer-implemented method of claim 43, wherein the arc transition component and the nozzle body are formed from different materials.

49. The computer-implemented method of claim 43, wherein the noble metal of the arc transition component is silver.

50. The computer-implemented method of claim 49, wherein the material of the arc transition component is silver alloy.

51. The computer-implemented method of claim 43, further comprising repeatedly toggling, by the plasma arc torch, between generating the pilot arc and the transferred arc for at least 90 seconds without plasma arc extinguishment.

52. A method of manufacturing a nozzle for a gas-cooled plasma arc torch, the method comprising:
forming a nozzle body from a first metal, the nozzle body comprising a proximal portion and a distal portion extending along a longitudinal axis, wherein the distal portion of the nozzle body comprises a first bore;
forming an arc transition component from a second metal, the arc transition component comprising a second bore, wherein the second metal of the arc transition component comprises a noble metal and the second metal is different from the first metal; and
coupling the arc transition component to the distal portion of the nozzle body such that the second bore substantially aligns with the first bore.

53. The method of claim 52, wherein the noble metal of the arc transition component is silver.

54. The method of claim 53, wherein the second metal of the arc transition component is a silver alloy.

55. The method of claim 53, wherein the second metal of the arc transition component comprises at least about 45% silver.

56. The method of claim 52, wherein the first metal is copper.

57. The method of claim 52, wherein the arc transition component is at least one of brazed, metallurgically bonded, stamped, frictional welded, swaged, ultrasonically welded or press fit onto the distal portion of the nozzle body.

58. The method of claim 52, wherein the arc transition component has a washer-like shape.

59. The method of claim 52, wherein the arc transition component comprises a coating on at least one of an end face of the distal portion of the nozzle body, an interior surface of the first bore, or an interior surface of the second bore.

60. The method of claim 52, wherein a thickness of the arc transition component along the longitudinal axis of the nozzle is between about 0.005 inches and about 0.15 inches.
